(19) United States
(12) Patent Application Publication
(10) Pub. No.: US 2026/0120957 A1
(43) Pub. Date: Apr. 30, 2026

(54) MULTILAYER ELECTRONIC COMPONENT

(71) Applicant: TDK Corporation, Tokyo (JP)

(72) Inventor: Jun NAKATSUTSUMI, Tokyo (JP)

(73) Assignee: TDK Corporation, Tokyo (JP)

(21) Appl. No.: 19/332,069

(22) Filed: Sep. 18, 2025

(30) Foreign Application Priority Data
Oct. 31, 2024 (JP) 2024-191614

(51) Int. Cl. H01G 4/40; H01G 2/22; H01G 4/232; H01G 4/30

(52) U.S. Cl. CPC H01G 4/40; H01G 2/22; H01G 4/232; H01G 4/30

(57) ABSTRACT

A multilayer electronic component includes: a capacitor; a ground conductor layer; a conductor layer that constitute, cooperatively with the ground conductor layer, at least a part of the capacitor; a structure; and a stack. The structure includes a columnar conductor having a first end and a second end located on sides opposite each other in a stacking direction. The first end is connected to the ground conductor layer. Another conductor for constituting a component other than the capacitor and the structure is not connected to the second end. The columnar conductor is disposed between the conductor layer and a side surface of the stack.

### CROSS-REFERENCE TO RELATED APPLICATION

This application claims the benefit of Japanese Priority Patent Application No. 2024-191614 filed on Oct. 31, 2024, the entire contents of which are incorporated herein by reference.

### BACKGROUND

The disclosure relates to a multilayer electronic component including a capacitor composed of a conductor layer.

The recent market demands for downsizing and space saving of compact mobile communication apparatuses and also requires miniaturization of band-pass filters for use in those communication apparatuses. One known example of a band-pass filter suitable for downsizing is a band-pass filter using a stack including a plurality of dielectric layers stacked together and a plurality of conductor layers.

As the band-pass filter, an LC band-pass filter composed by using an inductor and a capacitor is used, for example. JP 2024-23011 A discloses a filter device that includes: a stack including a plurality of stacked dielectric layers, a ground electrode, and a first resonator in which an inductor and a capacitor are connected in parallel. The first resonator includes a first via constituting the inductor and a capacitor electrode connected to the first via. The capacitor electrode overlaps the ground electrode, and the capacitor electrode and the ground electrode constitute the capacitor.

The characteristics of the band-pass filter can be adjusted with a capacitance of the capacitor or an inductance of the inductor, for example. In a case of a band-pass filter composed by using a stack, a capacitance of a capacitor can be adjusted by a size of a capacitor conductor layer that constitutes the capacitor, for example.

The capacitor conductor layer can actually work as a distributed constant circuit. For this reason, depending on the shape of the capacitor conductor layer, the characteristics of the band-pass filter may possibly shift from desired characteristics due to an inductance component of the capacitor conductor layer in some cases. In view of such a fact, when the capacitance of the capacitor is adjusted, the shape of the capacitor conductor layer is required to be adjusted while maintaining the desired capacitance. However, structural restrictions or the like of the stack have sometimes resulted in a difficulty in adjustment of the shape of the capacitor conductor layer. This prevents desired characteristics from being achieved in some cases.

The above problem applies, without being limited to a band-pass filter, to multilayer electronic components in general including a capacitor composed of a conductor layer.

### SUMMARY

A multilayer electronic component according to one embodiment of the disclosure includes: a first capacitor; a first ground conductor layer connected to a ground; a first capacitor conductor layer that constitutes, cooperatively with the first ground conductor layer, at least a part of the first capacitor; a first structure formed of a conductor; and a stack that integrates the first capacitor, the first ground conductor layer, the first capacitor conductor layer, and the first structure, the stack including a plurality of dielectric layers stacked together. The first structure includes at least one first columnar conductor extending in a direction parallel to a stacking direction of the plurality of dielectric layers, the at least one first columnar conductor having a first end and a second end that are located on sides opposite each other in the stacking direction. The first end is connected to the first ground conductor layer. The stack further includes another conductor for constituting at least one component other than the first capacitor and the first structure. The other conductor is not connected to the second end. The stack has a first surface and a second surface located at both respective ends of the stack in the stacking direction and a first side surface, a second side surface, a third side surface, and a fourth side surface that connect the first surface and the second surface. The first side surface and the second side surface face opposite directions. The third side surface and the fourth side surface face opposite directions. The at least one first columnar conductor is disposed between the first capacitor conductor layer and the first side surface.

Objects, features, and advantages of the disclosure will appear more fully from the following description.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a circuit diagram showing a circuit configuration of a multilayer electronic component according to an example embodiment of the disclosure.

FIG. 2 is a perspective view showing an external appearance of the multilayer electronic component according to the example embodiment of the disclosure.

FIG. 3 is a perspective view showing a stack of the multilayer electronic component according to the example embodiment of the disclosure.

FIG. 4A to FIG. 4C are explanatory diagrams showing respective patterned surfaces of first to third dielectric layers of the stack of the multilayer electronic component according to the example embodiment of the disclosure.

FIG. 5A to FIG. 5C are explanatory diagrams showing respective patterned surfaces of fourth to sixth dielectric layers of the stack of the multilayer electronic component according to the example embodiment of the disclosure.

FIG. 6A to FIG. 6C are explanatory diagrams showing respective patterned surfaces of seventh to ninth dielectric layers of the stack of the multilayer electronic component according to the example embodiment of the disclosure.

FIG. 7A and FIG. 7B are explanatory diagrams showing respective patterned surfaces of tenth and eleventh dielectric layers of the stack of the multilayer electronic component according to the example embodiment of the disclosure.

FIG. 7C is an explanatory diagram showing a patterned surface of twelfth to fourteenth dielectric layers of the stack of the multilayer electronic component according to the example embodiment of the disclosure.

FIG. 8A to FIG. 8C are explanatory diagrams showing respective patterned surfaces of fifteenth to seventeenth dielectric layers of the stack of the multilayer electronic component according to the example embodiment of the disclosure.

FIG. 9A and FIG. 9B are explanatory diagrams showing respective patterned surfaces of eighteenth and nineteenth dielectric layers of the stack of the multilayer electronic component according to the example embodiment of the disclosure.

FIG. 10 is a perspective view showing an internal structure of the stack of the multilayer electronic component according to the example embodiment of the disclosure.

FIG. 11 is a side view showing the internal structure of the stack of the multilayer electronic component according to the example embodiment of the disclosure.

FIG. 12 is a characteristic chart showing pass attenuation characteristics of each model obtained by a simulation.

### DETAILED DESCRIPTION

One object of the disclosure is to provide a multilayer electronic component including a capacitor composed of a conductor layer, which is capable of achieving adjustment of characteristics within structural restrictions.

In the following, some example embodiments and modification examples of the disclosure will be described in detail with reference to the accompanying drawings. Note that the following description is directed to illustrative examples of the disclosure and not to be construed as limiting the technology. Elements including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Similar elements are denoted with the same reference numerals to avoid redundant descriptions.

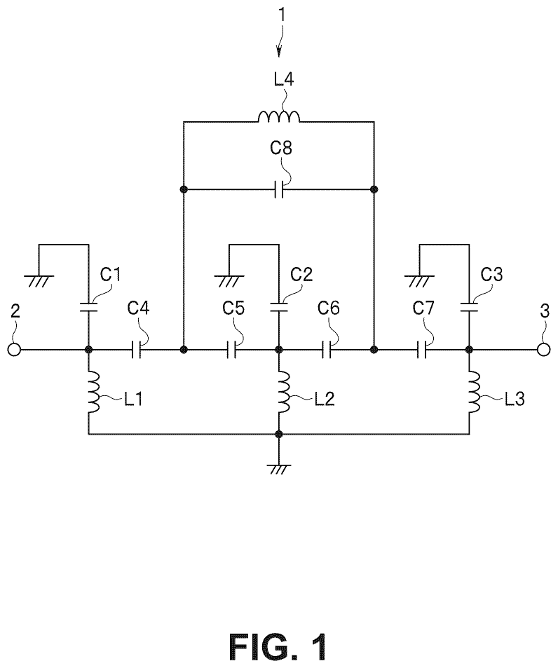

First, reference is made to FIG. 1 to describe a configuration of a multilayer electronic component (hereinafter referred to simply as an electronic component) 1 according to an example embodiment of the disclosure. FIG. 1 is a circuit diagram showing a circuit configuration of the electronic component 1 according to the example embodiment.

The electronic component 1 includes a first signal terminal 2, a second signal terminal 3, inductors L1, L2, L3, and L4, capacitors C1, C2, C3, C4, C5, C6, C7, and C8. Each of the first and second signal terminals 2 and 3 is a terminal for inputting or outputting a signal. In other words, when a signal is input to the first signal terminal 2, the signal is output from the second signal terminal 3. When a signal is input to the second signal terminal 3, the signal is output from the first signal terminal 2.

The inductors L1 to L4 and the capacitors C1 to C8 are provided between the first signal terminal 2 and the second signal terminal 3 in a circuit configuration. The inductors L1 to L4 and the capacitors C1 to C8 constitute a band-pass filter that selectively passes a signal of a frequency within a predetermined passband. Therefore, it can be said that the electronic component 1 includes a band-pass filter including the inductors L1 to L4 and the capacitors C1 to C8. Note that, in the application, the expression “in the (a) circuit configuration” is used to indicate an arrangement in a circuit diagram, not an arrangement in physical configuration.

The inductors L1, L2, and L3 are provided in this order from the first signal terminal 2 to the second signal terminal 3 in the circuit configuration. One end of the inductor L1 is connected to the first signal terminal 2. One end of the inductor L3 is connected to the second signal terminal 3.

One end of the capacitor C1 is connected to the one end of the inductor L1. One end of the capacitor C2 is connected to the one end of the inductor L2. One end of the capacitor C3 is connected to the one end of the inductor L3. The other end of each of the inductors L1 to L3 and the capacitors C1 to C3 is connected to a ground.

One end of the capacitor C4 is connected to the one end of the inductor L1. One end of the capacitor C5 is connected to the other end of the capacitor C4. One end of the capacitor C6 is connected to the other end of the capacitor C5. One end of the capacitor C7 is connected to the other end of the capacitor C6. The other end of the capacitor C7 is connected to the one end of the inductor L3. The one end of the inductor L2 is connected to a connection point between the capacitor C5 and the capacitor C6.

One end of the inductor LA is connected to a connection point between the capacitor C4 and the capacitor C5. The other end of the inductor L4 is connected to a connection point between the capacitor C6 and the capacitor C7. The capacitor C8 is connected in parallel with the inductor LA.

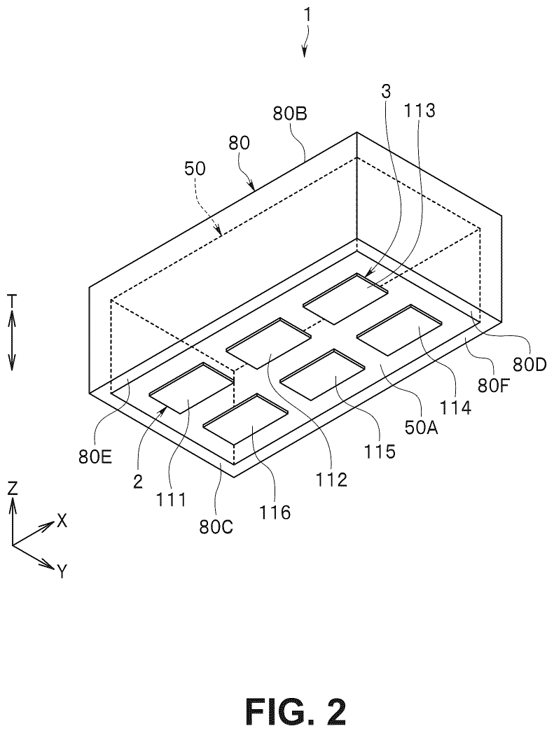

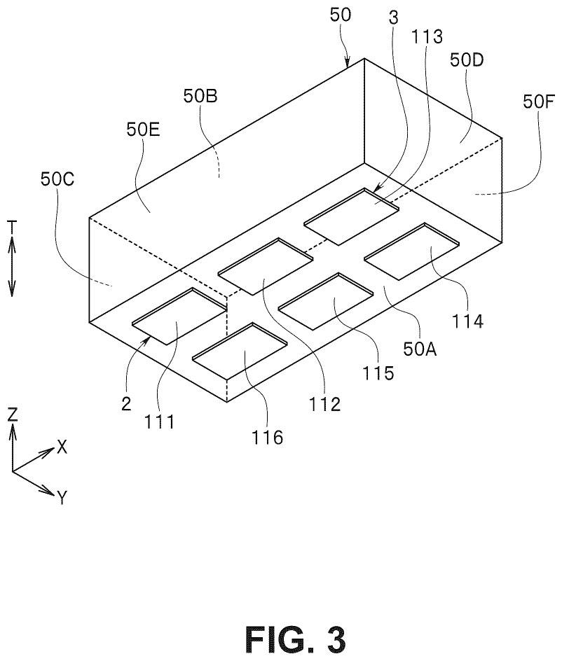

Reference is now made to FIG. 2 and FIG. 3 to describe other configurations of the electronic component 1. FIG. 2 is a perspective view showing an external appearance of the electronic component 1. FIG. 3 is a perspective view showing a stack of the electronic component 1.

The electronic component 1 includes a stack 50. The stack 50 includes a plurality of dielectric layers stacked together and a plurality of conductors (a plurality of conductor layers and a plurality of through holes). The stack 50 is used for integrating the first signal terminal 2, the second signal terminal 3, the inductors L1 to L4, and the capacitors C1 to C8. The inductors L1 to LA and the capacitors C1 to C8 are constituted by using a plurality of conductor layers.

The stack 50 has a first surface 50A and a second surface 50B located at both respective ends of the stack 50 in a stacking direction T of the plurality of dielectric layers, and four side surfaces 50C to 50F connecting the first surface 50A and the second surface 50B. The side surfaces 50C and 50D face opposite directions, and also the side surfaces 50E and 50F face opposite directions. The side surfaces 50C to 50F may each be perpendicular to both the first surface 50A and the second surface 50B.

Here, an X direction, a Y direction, and a Z direction are defined as shown in FIG. 2 and FIG. 3. The X direction, the Y direction, and the Z direction are orthogonal to one another. In the example embodiment, one direction parallel to the stacking direction T is defined as the Z direction. The opposite directions to the X, Y, and Z directions will be expressed as −X, −Y, and −Z directions, respectively. In addition, the expression “when viewed in a predetermined direction (for example, the stacking direction T)” may mean to see an object from a position away in the predetermined direction or one direction parallel to the predetermined direction.

As shown in FIG. 3, the first surface 50A is located at the end of the stack 50 in the −Z direction. The first surface 50A serves also as a bottom surface of the stack 50. The second surface 50B is located at the end of the stack 50 in the Z direction. The second surface 50B serves also as a top surface of the stack 50. The side surface 50C is located at the end of the stack 50 in the −X direction. The side surface 50D is located at the end of the stack 50 in the X direction. The side surface 50E is located at the end of the stack 50 in the −Y direction. The side surface 50F is located at the end of the stack 50 in the Y direction.

As shown in FIG. 2 and FIG. 3, the electronic component 1 further includes electrodes 111, 112, 113, 114, 115, and 116 provided on the first surface 50A of the stack 50. The electrodes 111, 112, and 113 are arranged in this order in the X direction at a position closer to the side surface 50E than to the side surface 50F. The electrodes 114, 115, and 116 are arranged in this order in the −X direction at a position closer to the side surface 50F than to the side surface 50E.

The electrode 111 corresponds to the first signal terminal 2, and the electrode 113 corresponds to the second signal terminal 3. The first signal terminal 2 and the second signal terminal 3 are thus provided on the first surface 50A of the stack 50. Each of the electrodes 112, 114, 115, and 116 is connected to the ground.

The electronic component 1 further includes a shield conductor 80 formed of a conductor and integrated into the stack 50. The shield conductor 80 includes a first conductor part 80E provided on the side surface 50E of the stack 50 and a second conductor part 80F provided on the side surface 50F of the stack 50. In the example embodiment, in particular, the first conductor part 80E covers the entire or substantially the entire side surface 50E. The second conductor part 80F covers the entire or substantially the entire side surface 50F.

The shield conductor 80 further includes a conductor part 80B provided on the second surface 50B of the stack 50, a conductor part 80C provided on the side surface 50C of the stack 50, and a conductor part 80D provided on the side surface 50D of the stack 50. In the example embodiment, in particular, the conductor part 80B covers the entire second surface 50B. The conductor part 80C covers the entire or substantially the entire side surface 50C. The conductor part 80D covers the entire or substantially the entire side surface 50D.

The shield conductor 80 may include a plurality of metal layers stacked together. In this case, the first conductor part 80E, the second conductor part 80F, and the conductor parts 80B, 80C, and 80D may be continuous. In other words, each of the first and second conductor parts 80E and 80F may be connected to the conductor parts 80B, 80C, and 80D.

The shield conductor 80 is electrically connected to the electrodes 114, 115, and 116. The stack 50 includes a plurality of conductors for electrically connecting the shield conductor 80 and the electrodes 114, 115, and 116.

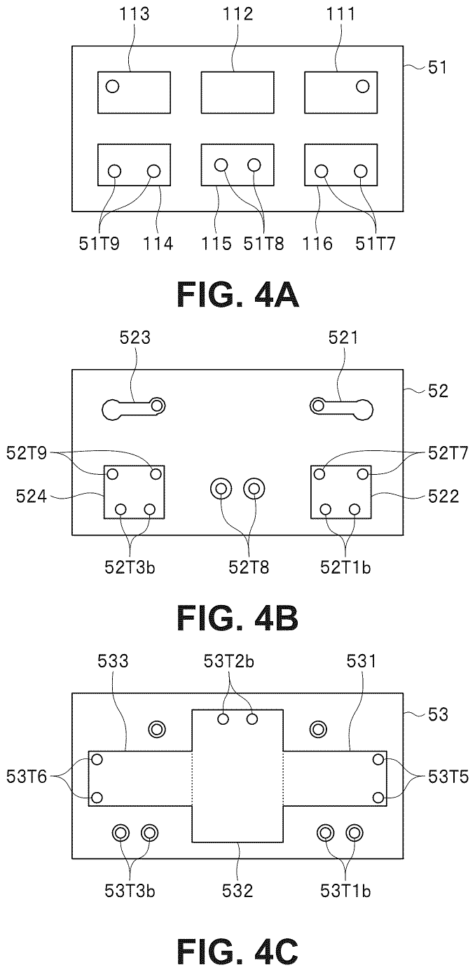

Next, an example of the plurality of dielectric layers and the plurality of conductors constituting the stack 50 will be described with reference to FIG. 4A to FIG. 9B. In this example, the stack 50 includes nineteen dielectric layers stacked together. Hereinafter, the nineteen dielectric layers will be referred to as first to nineteenth dielectric layers in the order from bottom to top. In addition, the first to nineteenth dielectric layers are denoted by reference numerals 51 to 69, respectively.

In FIG. 4A to FIG. 9A, each circle represents a through hole. The dielectric layers 51 to 69 each have a plurality of through holes. The plurality of through holes are each formed by filling a hole intended for a through hole with a conductive paste. Each of the plurality of through holes is connected to an electrode, a conductor layer, or another through hole. In the following description, a connection relationship between each of the plurality of through holes and an electrode, a conductor layer, or another through hole is described as a connection relationship in a state where the first to nineteenth dielectric layers 51 to 69 are stacked together. In FIG. 4A to FIG. 9A, a plurality of specific through holes among the plurality of through holes are denoted by respective reference numerals.

FIG. 4A shows a patterned surface of the first dielectric layer 51. The electrodes 111 to 116 are formed on the patterned surface of the dielectric layer 51.

In FIG. 4A, two through holes denoted by a reference numeral 51T7 are connected to the electrode 116. Note that, in the following description, a through hole denoted by the reference numeral 51T7 is simply referred to as the through hole 51T7. A through hole denoted by a reference numeral other than the through hole 51T7 is referred to in the same manner as for the through hole 51T7. Two through holes 51T8 shown in FIG. 4A are connected to the electrode 115. Two through holes 51T9 shown in FIG. 4A are connected to the electrode 114.

FIG. 4B shows a patterned surface of the second dielectric layer 52. Conductor layers 521, 522, 523, and 524 are formed on the patterned surface of the dielectric layer 52. The two through holes 51T7, two through holes 52T1b shown in FIG. 4B, and two through holes 52T7 shown in FIG. 4B are connected to the conductor layer 522. The two through holes 51T8 are connected to two through holes 52T8 shown in FIG. 4B. The two through holes 51T9, two through holes 52T3b shown in FIG. 4B, and two through holes 52T9 shown in FIG. 4B are connected to the conductor layer 524.

FIG. 4C shows a patterned surface of the third dielectric layer 53. Ground conductor layers 531, 532, and 533 are formed on the patterned surface of the dielectric layer 53. The ground conductor layer 532 is connected to the ground conductor layers 531 and 533. In FIG. 4C, each of a boundary between the ground conductor layer 531 and the ground conductor layer 532 and a boundary between the ground conductor layer 532 and the ground conductor layer 533 is indicated by a dotted line. One of the ground conductor layers 531 and 533 corresponds to “a first ground conductor layer” of the disclosure, and the other of the ground conductor layers 531 and 533 corresponds to “a second ground conductor layer” of the disclosure.

The two through holes 52T7, and two through holes 53T5 shown in FIG. 4C are connected to the ground conductor layer 531. The two through holes 52T8, and two through holes 53T2b shown in FIG. 4C are connected to the ground conductor layer 532. The two through holes 52T9, and two through holes 53T6 shown in FIG. 4C are connected to the ground conductor layer 533. The two through holes 52T1b and the two through holes 52T3b are connected respectively to two through holes 53T1b and two through holes 53T3b, which are shown in FIG. 4C.

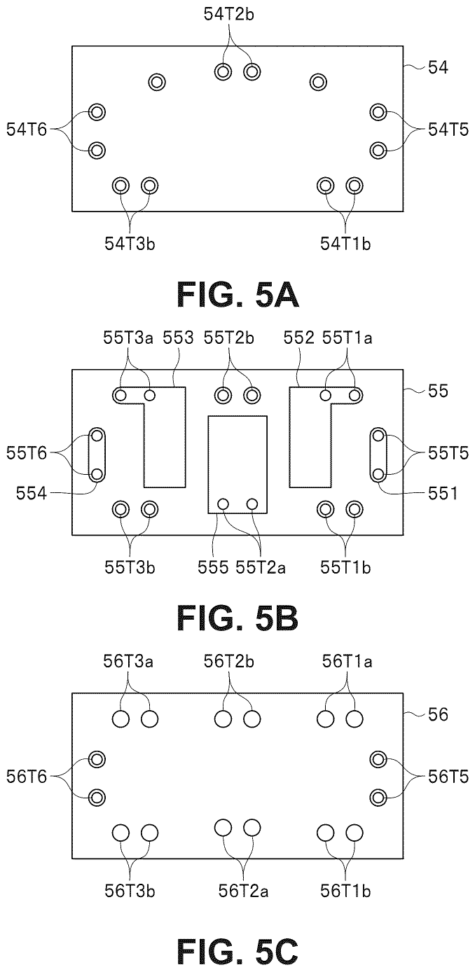

FIG. 5A shows a patterned surface of the fourth dielectric layer 54. The two through holes 53T1b, the two through holes 53T2b, the two through holes 53T3b, the two through holes 53T5, and the two through holes 53T6 are connected respectively to two through holes 54T1b, two through holes 54T2b, two through holes 54T3b, two through holes 54T5, and two through holes 54T6, which are shown in FIG. 5A.

FIG. 5B shows a patterned surface of the fifth dielectric layer 55. Conductor layers 551, 552, 553, 554, and 555 are formed on the patterned surface of the dielectric layer 55. Two through holes 55T1a, two through holes 55T2a, and two through holes 55T3a that are shown in FIG. 5B are connected respectively to the conductor layers 552, 555, and 553. The two through holes 54T5, and two through holes 55T5 shown in FIG. 5B are connected to the conductor layer 551. The two through holes 54T6 and two through holes 55T6 shown in FIG. 5B are connected to the conductor layer 554. The two through holes 54Tb1, the two through holes 54T2b, and the two through holes 54T3b are connected respectively to two through holes 55T1b, two through holes 55T2b, and two through holes 55T3b, which are shown in FIG. 5B.

FIG. 5C shows a patterned surface of the sixth dielectric layer 56. The two through holes 55T1a, the two through holes 55T1b, the two through holes 55T2a, the two through holes 55T2b, the two through holes 55T3a, the two through holes 55T3b, the two through holes 55T5, and the two through holes 55T6 are connected respectively to two through holes 56T1a, two through holes 56T1b, two through holes 56T2a, two through holes 56T2b, two through holes 56T3a, two through holes 56T3b, two through holes 56T5, and two through holes 56T6, which are shown in FIG. 5C.

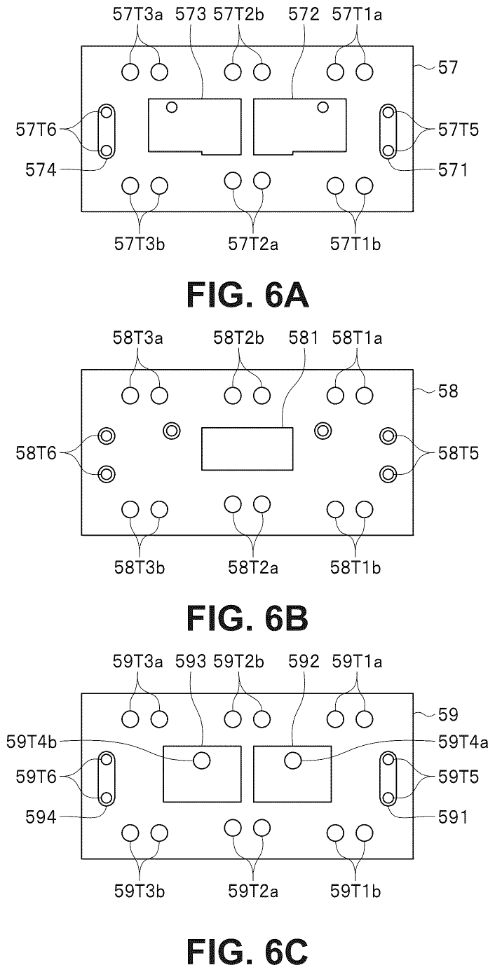

FIG. 6A shows a patterned surface of the seventh dielectric layer 57. Conductor layers 571, 572, 573, and 574 are formed on the patterned surface of the dielectric layer 57. The two through holes 56T5, and two through holes 57T5 shown in FIG. 6A are connected to the conductor layer 571. The two through holes 56T6, and two through holes 57T6 shown in FIG. 6A are connected to the conductor layer 574. The two through holes 56T1a, the two through holes 56T1b, the two through holes 56T2a, the two through holes 56T2b, the two through holes 56T3a, and the two through holes 56T3b are connected respectively to two through holes 57T1a, two through holes 57T1b, two through holes 57T2a, two through holes 57T2b, two through holes 57T3a, and two through holes 57T3b, which are shown in FIG. 6A.

FIG. 6B shows a patterned surface of the eighth dielectric layer 58. A conductor layer 581 is formed on the patterned surface of the dielectric layer 58. The two through holes 57T1a, the two through holes 57T1b, the two through holes 57T2a, the two through holes 57T2b, the two through holes 57T3a, the two through holes 57T3b, the two through holes 57T5, and the two through holes 57T6 are connected respectively to two through holes 58T1a, two through holes 58T1b, two through holes 58T2a, two through holes 58T2b, two through holes 58T3a, two through holes 58T3b, two through holes 58T5, and two through holes 58T6, which are shown in FIG. 6B.

FIG. 6C shows a patterned surface of the ninth dielectric layer 59. Conductor layers 591, 592, 593, and 594 are formed on the patterned surface of the dielectric layer 59. Through holes 59T4a and 59T4b shown in FIG. 6C are connected respectively to the conductor layers 592 and 593. The two through holes 58T5, and two through holes 59T5 shown in FIG. 6C are connected to the conductor layer 591. The two through holes 58T6, and two through holes 59T6 shown in FIG. 6C are connected to the conductor layer 594. The two through holes 58T1a, the two through holes 58T1b, the two through holes 58T2a, the two through holes 58T2b, the two through holes 58T3a, and the two through holes 58T3b are connected respectively to two through holes 59T1a, two through holes 59T1b, two through holes 59T2a, two through holes 59T2b, two through holes 59T3a, and two through holes 59T3b, which are shown in FIG. 6C.

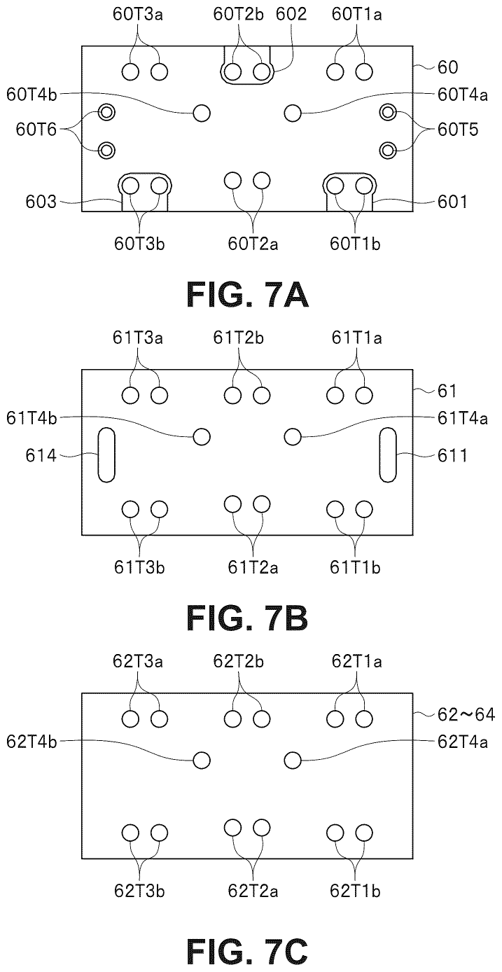

FIG. 7A shows a patterned surface of the tenth dielectric layer 60. Conductor layers 601, 602, and 603 are formed on the patterned surface of the dielectric layer 60. The two through holes 59T1b, and two through holes 60T1b shown in FIG. 7A are connected to the conductor layer 601. The two through holes 59T2b, and two through holes 60T2b shown in FIG. 7A are connected to the conductor layer 602. The two through holes 59T3b, and two through holes 60T3b shown in FIG. 7A are connected to the conductor layer 603. The two through holes 59T1a, the two through holes 59T2a, the two through holes 59T3a, the two through holes 59T5, and the two through holes 59T6 are connected respectively to two through holes 60T1a, two through holes 60T2a, two through holes 60T3a, two through holes 60T5, and two through holes 60T6, which are shown in FIG. 7A. The through holes 59T4a and 59T4b are connected respectively to through holes 60T4a and 60T4b shown in FIG. 7A.

The conductor layers 601 and 603 are connected to the second conductor part 80F of the shield conductor 80 (see FIG. 2). The conductor layer 602 is connected to the first conductor part 80E of the shield conductor 80 (see FIG. 2).

FIG. 7B shows a patterned surface of the eleventh dielectric layer 61. Conductor layers 611 and 614 are formed on the patterned surface of the dielectric layer 61. The two through holes 60T5 and the two through holes 60T6 are connected respectively to the conductor layers 611 and 614. The two through holes 60T1a, the two through holes 60T1b, the two through holes 60T2a, the two through holes 60T2b, the two through holes 60T3a, and the two through holes 60T3b are connected respectively to two through holes 61T1a, two through holes 61T1b, two through holes 61T2a, two through holes 61T2b, two through holes 61T3a, and two through holes 61T3b, which are shown in FIG. 7B. The through holes 60T4a and 60T4b are connected respectively to through holes 61T4a and 61T4b shown in FIG. 7B.

FIG. 7C shows a patterned surface of each of the twelfth to fourteenth dielectric layers 62 to 64. The two through holes 61T1a, the two through holes 61T1b, the two through holes 61T2a, the two through holes 61T2b, the two through holes 61T3a, and the two through holes 61T3b are connected respectively to two through holes 62T1a, two through holes 62T1b, two through holes 62T2a, two through holes 62T2b, two through holes 62T3a, and two through holes 62T3b that are formed on the dielectric layer 62. The through holes 61T4a and 61T4b are connected respectively to through holes 62T4a and 62T4b formed on the dielectric layer 62. Further, in the dielectric layers 62 to 64, every vertically adjacent through holes denoted by the same reference numerals are connected to each other.

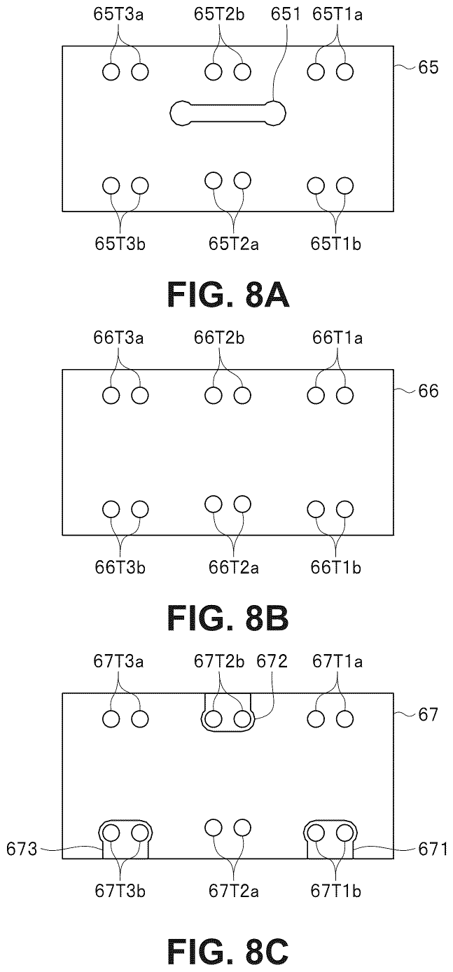

FIG. 8A shows a patterned surface of the fifteenth dielectric layer 65. A conductor layer 651 is formed on the patterned surface of the dielectric layer 65. The conductor layer 651 has a first end and a second end located at both longitudinal ends of the conductor layer 651. The through hole 62T4a formed in the dielectric layer 64 is connected to a portion of the conductor layer 651 near the first end. The through hole 62T4b formed in the dielectric layer 64 is connected to a portion of the conductor layer 651 near the second end.

The two through holes 62T1a, the two through holes 62T1b, the two through holes 62T2a, the two through holes 62T2b, the two through holes 62T3a, and the two through holes 62T3b that are formed in the dielectric layer 64 are connected respectively to two through holes 65T1a, two through holes 65T1b, two through holes 65T2a, two through holes 65T2b, two through holes 65T3a, and two through holes 65T3b, which are shown in FIG. 8A.

FIG. 8B shows a patterned surface of the sixteenth dielectric layer 66. The two through holes 65T1a, the two through holes 65T1b, the two through holes 65T2a, the two through holes 65T2b, the two through holes 65T3a, and the two through holes 65T3b are connected respectively to two through holes 66T1a, two through holes 66T1b, two through holes 66T2a, two through holes 66T2b, two through holes 66T3a, and two through holes 66T3b, which are shown in FIG. 8B.

FIG. 8C shows a patterned surface of the seventeenth dielectric layer 67. Conductor layers 671, 672, and 673 are formed on the patterned surface of the dielectric layer 67. The two through holes 66T1b, and two through holes 67T1b shown in FIG. 8C are connected to the conductor layer 671. The two through holes 66T2b, and two through holes 67T2b shown in FIG. 8C are connected to the conductor layer 672. The two through holes 66T3b, and two through holes 67T3b shown in FIG. 8C are connected to the conductor layer 673. The two through holes 66T1a, the two through holes 66T2a, and the two through holes 66T3a are connected respectively to two through holes 67T1a, two through holes 67T2a, and two through holes 67T3a, which are shown in FIG. 8C.

The conductor layers 671 and 673 are connected to the second conductor part 80F of the shield conductor 80 (see FIG. 2). The conductor layer 672 is connected to the first conductor part 80E of the shield conductor 80 (see FIG. 2).

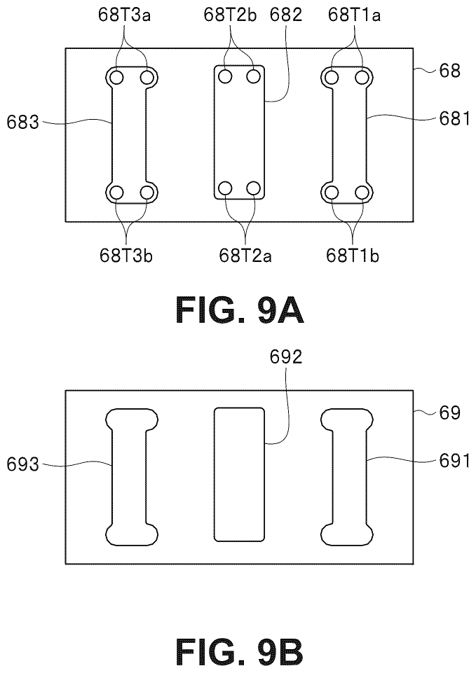

FIG. 9A shows a patterned surface of the eighteenth dielectric layer 68. Conductor layers 681, 682, and 683 are formed on the patterned surface of the dielectric layer 68. The conductor layer 681 has a first end and a second end located at both longitudinal ends of the conductor layer 681. The conductor layer 682 has a first end and a second end located at both longitudinal ends of the conductor layer 682. The conductor layer 683 has a first end and a second end located at both longitudinal ends of the conductor layer 683.

The first end of the conductor layer 681, the second end of the conductor layer 682, and the first end of the conductor layer 683 are located at positions closer to the first conductor part 80E of the shield conductor 80 (positions on the upper side in FIG. 9A) than to the second conductor part 80F of the shield conductor 80. The second end of the conductor layer 681, the first end of the conductor layer 682, and the second end of the conductor layer 683 are located at positions closer to the second conductor part 80F of the shield conductor 80 (positions on the lower side in FIG. 9A) than to the first conductor part 80E of the shield conductor 80.

The two through holes 67T1a, and two through holes 68T1a shown in FIG. 9A are connected to portions of the conductor layer 681 near the first end. The two through holes 67T1b, and two through holes 68T1b shown in FIG. 9A are connected to portions of the conductor layer 681 near the second end. The two through holes 67T2a, and two through holes 68T2a shown in FIG. 9A are connected to portions of the conductor layer 682 near the first end. The two through holes 67T2b, and two through holes 68T2b shown in FIG. 9A are connected to portions of the conductor layer 682 near the second end. The two through holes 67T3a, and two through holes 68T3a shown in FIG. 9A are connected to portions of the conductor layer 683 near the first end. The two through holes 67T3b, and two through holes 68T3b shown in FIG. 9A are connected to portions of the conductor layer 683 near the second end.

FIG. 9B shows a patterned surface of the nineteenth dielectric layer 69. Conductor layers 691, 692, and 693 are formed on the patterned surface of the dielectric layer 69. The conductor layer 691 has a first end and a second end located at both longitudinal ends of the conductor layer 691. The conductor layer 692 has a first end and a second end located at both longitudinal ends of the conductor layer 692. The conductor layer 693 has a first end and a second end located at both longitudinal ends of the conductor layer 693.

The first end of the conductor layer 691, the second end of the conductor layer 692, and the first end of the conductor layer 693 are located at positions closer to the first conductor part 80E of the shield conductor 80 (positions on the upper side in FIG. 9B) than to the second conductor part 80F of the shield conductor 80. The second end of the conductor layer 691, the first end of the conductor layer 692, and the second end of the conductor layer 693 are located at positions closer to the second conductor part 80F of the shield conductor 80 (positions on the lower side in FIG. 9B) than to the first conductor part 80E of the shield conductor 80.

The two through holes 68T1a are connected to portions of the conductor layer 691 near the first end. The two through holes 68T1b are connected to portions of the conductor layer 691 near the second end. The two through holes 68T2a are connected to portions of the conductor layer 692 near the first end. The two through holes 68T2b are connected to portions of the conductor layer 692 near the second end. The two through holes 68T3a are connected to portions of the conductor layer 693 near the first end. The two through holes 68T3b are connected to portions of the conductor layer 693 near the second end.

The stack 50 shown in FIG. 3 includes the first to nineteenth dielectric layers 51 to 69 that are stacked together such that the patterned surface of the first dielectric layer 51 serves as the first surface 50A of the stack 50 and the surface of the nineteenth dielectric layer 69 opposite the patterned surface thereof serves as the second surface 50B of the stack 50.

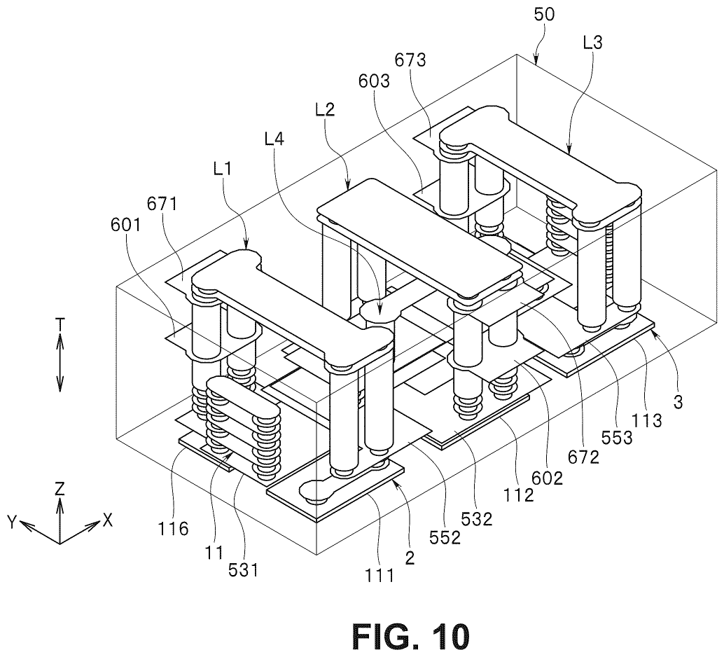

FIG. 10 shows an internal structure of the stack 50 formed by the first to nineteenth dielectric layers 51 to 69 being stacked. As shown in FIG. 10, in the internal structure of the stack 50, the plurality of conductor layers and the plurality of through holes shown in FIGS. 4A to 9B are stacked.

Correspondence between the components of the circuit of the electronic component 1 shown in FIG. 1 and the components of the internal structure of the stack 50 shown in FIG. 4A to FIG. 9B will be described below. The conductor layers 681 and 691, and the through holes 52T1b, 53T1b, 54T1b, 55T1a, 55T1b, 56T1a, 56T1b, 57T1a, 57T1b, 58T1a, 58T1b, 59T1a, 59T1b, 60T1a, 60T1b, 61T1a, 61T1b, 62T1a, 62T1b, 65T1a, 65T1b, 66T1a, 66T1b, 67T1a, 67T1b, 68T1a, and 68T1b constitute at least a part of the inductor L1.

The conductor layers 682 and 692, and the through holes 53T2b, 54T2b, 55T2a, 55T2b, 56T2a, 56T2b, 57T2a, 57T2b, 58T2a, 58T2b, 59T2a, 59T2b, 60T2a, 60T2b, 61T2a, 61T2b, 62T2a, 62T2b, 65T2a, 65T2b, 66T2a, 66T2b, 67T2a, 67T2b, 68T2a, and 68T2b constitute at least a part of the inductor L2.

The conductor layers 683 and 693, and the through holes 52T3b, 53T3b, 54T3b, 55T3a, 55T3b, 56T3a, 56T3b, 57T3a, 57T3b, 58T3a, 58T3b, 59T3a, 59T3b, 60T3a, 60T3b, 61T3a, 61T3b, 62T3a, 62T3b, 65T3a, 65T3b, 66T3a, 66T3b, 67T3a, 67T3b, 68T3a, and 68T3b constitute at least a part of the inductor L3.

The conductor layer 651 and the through holes 59T4a, 59T4b, 60T4a, 60T4b, 61T4a, 61T4b, 62T4a, and 62T4b constitute at least a part of the inductor LA.

The ground conductor layer 531, the conductor layer 552, and the dielectric layers 53 and 54 between these conductor layers constitute at least a part of the capacitor C1. The ground conductor layer 532, the conductor layer 555, and the dielectric layers 53 and 54 between these conductor layers constitute at least a part of the capacitor C2. The ground conductor layer 533, the conductor layer 553, and the dielectric layers 53 and 54 between these conductor layers constitute at least a part of the capacitor C3.

The conductor layers 552 and 572, and the dielectric layers 55 and 56 between these conductor layers constitute at least a part of the capacitor C4. The conductor layers 555 and 572, and the dielectric layers 55 and 56 between these conductor layers constitute at least a part of the capacitor C5. The conductor layers 555 and 573, and the dielectric layers 55 and 56 between these conductor layers constitute at least a part of the capacitor C6. The conductor layers 553 and 573, and the dielectric layers 55 and 56 between these conductor layers constitute at least a part of the capacitor C7. The conductor layers 572, 573, 581, 592, and 593, and the dielectric layers 57 and 58 between these conductor layers constitute at least a part of the capacitor C8.

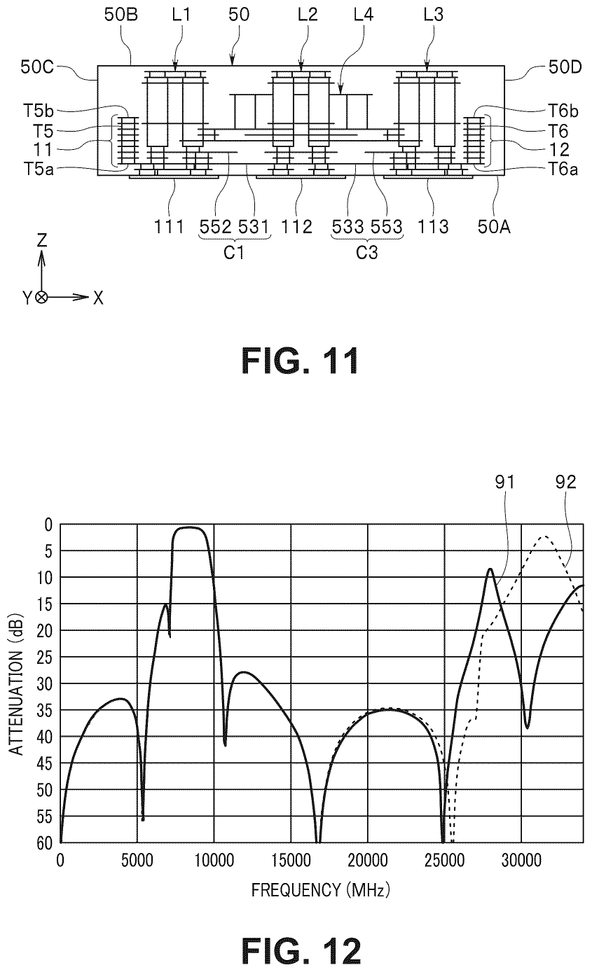

Reference is now made to FIG. 1 to FIG. 11 to describe structural features of the electronic component 1 according to the example embodiment. FIG. 11 is a side view showing an internal structure of the stack 50. As described above, the stack 50 includes the capacitors C1 and C3. The conductor layer 552 constitutes, cooperatively with the ground conductor layer 531, at least a part of the capacitor C1. The conductor layer 553 constitutes, cooperatively with the ground conductor layer 533, at least a part of the capacitor C3. Each of the ground conductor layers 531 and 533 is not directly connected to the shield conductor 80.

The stack 50 further includes structures 11 and 12 each formed of a conductor. Each of the structures 11 and 12 is integrated with the stack 50. The structure 11 is disposed at a position closer to the side surface 50C than to the side surface 50D, and connected to the ground conductor layer 531. The structure 12 is disposed at a position closer to the side surface 50D than to the side surface 50C, and connected to the ground conductor layer 533.

It is not necessary to dispose any conductor between the structure 11 and the side surface 50C. It is not necessary to dispose any conductor between the structure 12 and the side surface 50D.

Here, a columnar structure constituted of one through hole or a plurality of through holes is referred to as a columnar conductor. When the columnar conductor is constituted of a plurality of through holes, the plurality of through holes are connected in series. The columnar conductor extends in the direction parallel to the stacking direction T. Each of the structures 11 and 12 includes at least one columnar conductor.

In the example embodiment, the structure 11 includes, as at least one columnar conductor, a plurality of columnar conductors T5 that are arranged in a direction orthogonal to the stacking direction T. In the example shown in FIG. 10 and FIG. 11, the plurality of columnar conductor T5 are two columnar conductors T5 arranged in the direction parallel to the Y direction. The dimensions of the respective two columnar conductors T5 in the stacking direction T may be the same or different from each other. Note that the number of the at least one columnar conductor of the structure 11 is not limited to two, but may be one or three or more.

The two columnar conductors T5 are formed by the through holes 53T5, 54T5, 55T5, 56T5, 57T5, 58T5, 59T5, and 60T5 being connected in series. In addition, each of the two columnar conductors T5 has a first end T5a and a second end T5b located on sides opposite each other in the stacking direction T. The first end T5a is connected to the ground conductor layer 531. To the second end T5b, the conductor layer of the structure 11 to be described later is connected, but other than this conductor layer, no other conductor is connected. In the example embodiment, in particular, another conductor for constituting at least one component other than the capacitor C1 and the structure 11 is not connected to the second end T5b.

Furthermore, in the example embodiment, the structure 12 includes, as at least one columnar conductor, a plurality of columnar conductors T6 arranged in the direction orthogonal to the stacking direction T. In the example shown in FIG. 10 and FIG. 11, the plurality of columnar conductors T6 are two columnar conductors T6 arranged in the direction parallel to the Y direction. The dimensions of the respective two columnar conductors T6 in the stacking direction T may be the same or different from each other. Note that the number of the at least one columnar conductor of the structure 12 is not limited to two, but may be one or three or more.

The two columnar conductors T6 are formed by the through holes 53T6, 54T6, 55T6, 56T6, 57T6, 58T6, 59T6, and 60T6 being connected in series. In addition, each of the two columnar conductors T6 has a third end T6a and a fourth end T6b located on sides opposite each other in the stacking direction T. The third end Toa is connected to the ground conductor layer 533. To the fourth end T6b, the conductor layer of the structure 12 to be described later is connected, but other than this conductor layer, no other conductor is connected. In the example embodiment, in particular, another conductor for constituting at least one component other than the capacitor C3 and the structure 12 is not connected to the fourth end T6b.

The structure 11 may further include at least one conductor layer connected to at least one columnar conductor. In the example embodiment, the structure 11 includes, as the at least one columnar conductor, the conductor layers 551, 571, 591, and 611. Each of the conductor layers 551, 571, 591, and 611 is connected to the two columnar conductors T5. In particular, the conductor layer 611 is connected to the second end T5b of each of the two columnar conductors T5.

The structure 12 may further include at least one conductor layer connected to at least one columnar conductor. In the example embodiment, the structure 12 includes, as the at least one columnar conductor, the conductor layers 554, 574, 594, and 614. Each of the conductor layers 554, 574, 594, and 614 is connected to the two columnar conductors T6. In particular, the conductor layer 614 is connected to the fourth end T6b of each of the two columnar conductors T6.

Next, a relationship between the structures 11, 12 and the ground conductor layers 531, 533 will be described. Each of the ground conductor layers 531 and 533 is connected to the ground via at least one electrode of the electrodes 114, 115, and 116. In the example embodiment, in particular, the ground conductor layer 531 is connected to the ground via the electrode 116, the two through holes 51T7, the conductor layer 522, and the two through holes 52T7. The ground conductor layers 533 is connected to the ground via the electrode 114, the two through holes 51T9, the conductor layer 524, and the two through holes 52T9.

In addition, the ground conductor layers 531 and 533 are connected to the ground conductor layer 532. The ground conductor layer 532 is connected to the ground via the electrode 115, the two through holes 51T8, and the two through holes 52T8. Therefore, it can be also said that the ground conductor layer 531 is connected to the ground via the ground conductor layers 532 and 533. Similarly, it can be also said that the ground conductor layer 533 is connected to the ground via the ground conductor layers 531 and 532.

Each of the ground conductor layers 531 and 533 is disposed at a position closer to the first surface 50A than to the second surface 50B. The structure 11 is disposed between the ground conductor layer 531 and the second surface 50B. The structure 12 is disposed between the ground conductor layer 533 and the second surface 50B.

Next, the relationship between the structures 11, 12 and the capacitors C1, C3 will be described. The conductor layer 552 constituting at least a part of the capacitor C1 is electrically connected to the electrode 111 corresponding to the first signal terminal 2, via the plurality of through holes and the conductor layer 521. In other words, the conductor layer 552 is electrically connected to the first signal terminal 2. As shown in FIG. 11, the two columnar conductors T5 are disposed between the conductor layer 552 and the side surface 50C.

The conductor layer 553 constituting at least a part of the capacitor C3 is electrically connected to the electrode 113 corresponding to the second signal terminal 3, via the plurality of through holes and the conductor layer 523. In other words, the conductor layer 553 is electrically connected to the second signal terminal 3. The two columnar conductors T6 are disposed between the conductor layer 553 and the side surface 50D.

Next, features related to the inductors L1 to L4 will be described. The inductors L1 to L3 are arranged in this order, from the side surface 50C of the stack 50 towards the side surface 50D of the stack 50. The inductor L4 is provided so as to overlap the inductor L2 when viewed in the stacking direction T. The inductors L1 to L4 are disposed between the structure 11 and the structure 12. In the example embodiment, in particular, the structure 11 is disposed between the inductor L1 and the side surface 50C. The structure 12 is disposed between the inductor L3 and the side surface 50D.

The inductor L1 includes: two first columnar conductors; two second columnar conductors; and the conductor layer 681 that connects the two first columnar conductors and the two second columnar conductors, and the inductor L1 is wound around an axis extending in the direction orthogonal to the stacking direction T. The two first columnar conductors are constituted of the through holes 55T1a, 56T1a, 57T1a, 58T1a, 59T1a, 60T1a, 61T1a, 62T1a, 65T1a, 66T1a, and 67T1a, and the two second columnar conductors are constituted of the through holes 52T1b, 53T1b, 54T1b, 55T1b, 56T1b, 57T1b, 58T1b, 59T1b, 60T1b, 61T1b, 62T1b, 65T1b, 66T1b, 67T1b, and 68T1b. The inductor L1 further includes the conductor layer 691, and the through holes 68T1a and 68T1b connecting the conductor layer 681 and the conductor layer 691.

The two second columnar conductors of the inductor L1 are connected to the second conductor part 80F of the shield conductor 80 (see FIG. 2), via the conductor layers 601 and 671.

The inductor L2 includes: two first columnar conductors; two second columnar conductors; and the conductor layer 682 that connects the two first columnar conductors and the two second columnar conductors, and the inductor L2 is wound around the axis extending in the direction orthogonal to the stacking direction T. The two first columnar conductors are constituted of the through holes 55T2a, 56T2a, 57T2a, 58T2a, 59T2a, 60T2a, 61T2a, 62T2a, 65T2a, 66T2a, and 67T2a, and the two second columnar conductors are constituted of the through holes 53T2b, 54T2b, 55T2b, 56T2b, 57T2b, 58T2b, 59T2b, 60T2b, 61T2b, 62T2b, 65T2b, 66T2b, and 67T2b. The inductor L2 further includes the conductor layer 692, and the through holes 68T2a and 68T2b connecting the conductor layer 682 and the conductor layer 692.

The two second columnar conductors of the inductor L2 are connected to the first conductor part 80E of the shield conductor 80 (see FIG. 2), via the conductor layers 602 and 672.

The inductor L3 includes: two first columnar conductors; two second columnar conductors; and the conductor layer 683 that connects the two first columnar conductors and the two second columnar conductors, and the inductor L3 is wound around the axis extending in the direction orthogonal to the stacking direction T. The two first columnar conductors are constituted of the through holes 55T3a, 56T3a, 57T3a, 58T3a, 59T3a, 60T3a, 61T3a, 62T3a, 65T3a, 66T3a, and 67T3a, and the two second columnar conductors are constituted of the through holes 52T3b, 53T3b, 54T3b, 55T3b, 56T3b, 57T3b, 58T3b, 59T3b, 60T3b, 61T3b, 62T3b, 65T3b, 66T3b, and 67T3b. The inductor L3 further includes the conductor layer 693, and the through holes 68T3a and 68T3b connecting the conductor layer 683 and the conductor layer 693.

The two second columnar conductors of the inductor L3 are connected to the second conductor part 80F of the shield conductor 80 (see FIG. 2), via the conductor layers 603 and 673.

The inductor L1 has an opening surrounded by the two first columnar conductors of the inductor L1, the two second columnar conductors of the inductor L1, and the conductor layer 681. The inductor L2 has an opening surrounded by the two first columnar conductors of the inductor L2, the two second columnar conductors of the inductor L2, and the conductor layer 682. The inductor L3 has an opening surrounded by the two first columnar conductors of the inductor L3, the two second columnar conductors of the inductor L3, and the conductor layer 683. The inductors L1 to L3 are disposed such that the opening of the inductor L1, the opening of the inductor L2, and the opening of the inductor L3 overlap one another when viewed in the X direction.

The structure 11 may be disposed so as to overlap the opening of the inductor L1 when viewed in the X direction. The structure 12 may be disposed so as to overlap the opening of the inductor L3 when viewed in the X direction.

The inductor L4 includes: one first columnar conductor; one second columnar conductor; and the conductor layer 651 that connects the first columnar conductor and the second columnar conductor, and the inductor L4 is wound around the axis extending in the direction orthogonal to the stacking direction T. The one first columnar conductor is constituted of the through holes 59T4a, 60T4a, 61T4a, and 62T4a, and the one second columnar conductor is constituted of the through holes 59T4b, 60T4b, 61T4b, and 62T4b. The inductor L4 may be disposed so as to intersect the opening of the inductor L2.

Next, operation and effects of the electronic component 1 according to the example embodiment will be described. The electronic component 1 according to the example embodiment includes a band-pass filter including the inductors L1 to L4, and the capacitors C1 to C8. In some cases, the band-pass filter is required to be configured such that pass attenuation is increased in a specific frequency domain higher than the passband of the band-pass filter (for example, frequency domain containing frequency four times the center frequency of the passband). However, if the conductor layers constituting the inductors L1 to L4 and the capacitors C1 to C8 work as a distributed constant circuit, there is a case where the attenuation cannot be increased sufficiently in the above-described specific frequency domain.

During the course of research of the inventors of this application, it can be found that the shape of the ground conductor layer 531 constituting at least a part of the capacitor C1 and the shape of the ground conductor layer 533 constituting at least a part of the capacitor C3 affect the pass attenuation in the above-described specific frequency domain. Specifically, it was found that the pass attenuation in the above-described specific frequency domain can be increased by decreasing or increasing the size of the shape of each of the ground conductor layers 531 and 533. However, when the size of the shape of each of the ground conductor layers 531 and 533 is decreased, the pass attenuation in the above-described specific frequency domain could not have been sufficiently increased while maintaining other characteristics of the band-pass filter. In addition, due to the limitation on the size of the stack 50, the size of the shape of each of the ground conductor layers 531 and 533 could not have been sufficiently increased.

In contrast, the electronic component 1 according to the example embodiment includes the structures 11 and 12 each formed of conductors. As described above, the first end T5a of each of the two columnar conductors T5 of the structure 11 is connected to the ground conductor layer 531. To the second end T5b of each of the two columnar conductors T5, except for the conductor layer 611 of the structure 11, no other conductor is connected. In other words, in the example embodiment, the structure 11 is not used as wiring, and can be regarded as a part of the ground conductor layer 531. Similarly, the third end Toa of each of the two columnar conductors T6 of the structure 12 is connected to the ground conductor layer 533. To the fourth end T6b of each of the two columnar conductors T6, except for the conductor layer 614 of the structure 12, no other conductor is connected. In other words, in the example embodiment, the structure 12 is not used as wiring, and can be regarded as a part of the ground conductor layer 533.

The two columnar conductors T5 are disposed between the conductor layer 552 that constitutes at least a part of the capacitor C1 cooperatively with the ground conductor layer 531 and the side surface 50C. The two columnar conductors T6 are disposed between the conductor layer 553 that constitutes at least a part of the capacitor C3 cooperatively with the ground conductor layer 533, and the side surface 50D. According to the example embodiment, the above-described configuration enables adjustment of the characteristics to be achieved within the structural restrictions. Hereinafter, such effects will be described using results of a simulation.

In the simulation, a model of an example and a model of a comparative example were used. The model of the example is a model of the electronic component 1 according to the example embodiment. In the model of the example, the electronic component 1 is designed such that the passband of the electronic component 1 includes a frequency domain of 7.7 GHZ to 8.2 GHz.

The model of the comparative example is a model of an electronic component of the comparative example. The electronic component of the comparative example has the same configurations as those of the electronic component 1 according to the example embodiment, except that the structures 11 and 12 are not provided.

In the simulation, the pass attenuation characteristics between the first signal terminal 2 and the second signal terminal 3 were obtained for each of the model of the example and the model of the comparative example.

FIG. 12 is a characteristic chart showing the pass attenuation characteristics of each of the models. In FIG. 12, the horizontal axis indicates the frequency, and the vertical axis indicates the attenuation. In addition, in FIG. 12, a curve denoted by a reference numeral 91 represents the pass attenuation characteristics in the model of the example. A curve denoted by a reference numeral 92 represents the pass attenuation characteristics in the model of the comparative example.

From FIG. 12, it can be found that in the specific frequency domain containing the frequency four times the center frequency of the passband, the pass attenuation (91) in the model of the example is larger than the pass attenuation (92) in the model of the comparative example. As understood from the results of the simulation, according to the example embodiment, adjustment of the characteristics can be achieved within the structural restrictions.

Note that the disclosure is not limited to the foregoing example embodiment, and various modifications can be made thereto. For example, the structures in the disclosure can be applied not only to the case where the pass attenuation is increased in the specific frequency domain but also to the case where desired characteristics are achieved in electronic components having various circuit configurations in which the ground conductor layers can work as a distributed constant circuit, as long as the structures meet the requirements of claims.

In addition, one of the structure 11 and structure 12 does not have to be provided. Furthermore, the numbers and the positions of the columnar conductors and the conductor layers that are included in each of the structures 11 and 12 are not limited to the examples shown in the example embodiment, but are optional. For example, the number of the conductor layers included in each of the structures 11 and 12 may be three or less or five or more.

In addition, the electronic component 1 of the disclosure may include another structure connected to another conductor layer, instead of the structures 11 and 12, or in addition to the structures 11 and 12. The configuration of the other structure is the same as that of each of the structures 11 and 12. The other structure may be the one that increases the pass attenuation in the specific frequency domain including the frequency four times the center frequency of the passband or the one that increases the pass attenuation in another specific frequency domain not including the frequency four times the center frequency of the passband.

In addition, each of the ground conductor layers 531 and 533 may be disposed at a position closer to the second surface 50B than to the first surface 50A. In this case, the structure 11 may be disposed between the ground conductor layer 531 and the first surface 50A. The structure 12 may be disposed between the ground conductor layer 533 and the first surface 50A.

Furthermore, each of the ground conductor layers 531 and 533 does not have to be connected to the ground conductor layer 532.

As described above, a multilayer electronic component according to one embodiment of the disclosure includes: a first capacitor; a first ground conductor layer connected to a ground; a first capacitor conductor layer that constitutes, cooperatively with the first ground conductor layer, at least a part of the first capacitor; a first structure formed of a conductor; and a stack that integrates the first capacitor, the first ground conductor layer, the first capacitor conductor layer, and the first structure, the stack including a plurality of dielectric layers stacked together. The first structure includes at least one first columnar conductor extending in a direction parallel to a stacking direction of the plurality of dielectric layers, the at least one first columnar conductor having a first end and a second end that are located on sides opposite each other in the stacking direction. The first end is connected to the first ground conductor layer. The stack further includes another conductor for constituting at least one component other than the first capacitor and the first structure. The other conductor is not connected to the second end. The stack includes a first surface and a second surface located at both respective ends of the stack in the stacking direction, and a first side surface, a second side surface, a third side surface, and a fourth side surface that connect the first surface and the second surface. The first side surface and the second side surface face opposite directions. The third side surface and the fourth side surface face opposite directions. The at least one first columnar conductor is disposed between the first capacitor conductor layer and the first side surface.

In the multilayer electronic component according to one embodiment of the disclosure, the first ground conductor layer may be disposed at a position closer to the first surface than to the second surface. The first structure may be disposed between the first ground conductor layer and the second surface.

In the multilayer electronic component according to one embodiment of the disclosure, the at least one first columnar conductor may include a plurality of first columnar conductors arranged in a direction orthogonal to the stacking direction.

In the multilayer electronic component according to one embodiment of the disclosure, the first structure may further include at least one conductor layer connected to the at least one first columnar conductor.

The multilayer electronic component according to one embodiment of the disclosure may further include a band-pass filter including the first capacitor and at least one inductor integrated with the stack.

The multilayer electronic component according to one embodiment of the disclosure may further include: a second capacitor; a second ground conductor layer connected to the ground; a second capacitor conductor layer that constitutes, cooperatively with the second ground conductor layer, at least a part of the second capacitor; and a second structure formed of a conductor. The second capacitor, the second ground conductor layer, the second capacitor conductor layer, and the second structure may be integrated with the stack. The second structure may include at least one second columnar conductor extending in a direction parallel to the stacking direction, the at least one second columnar conductor having a third end and a fourth end that are located on sides opposite each other in the stacking direction. The third end may be connected to the second ground conductor layer. The at least one component does not have to include the second capacitor and the second structure. The other conductor does not have to be connected to the fourth end. The at least one second columnar conductor may be disposed between the second capacitor conductor layer and one of the second side surface, the third side surface, and the fourth side surface.

The multilayer electronic component according to one embodiment of the disclosure may further include an inductor disposed between the first structure and the second structure.

The multilayer electronic component according to one embodiment of the disclosure may further include a signal terminal disposed on the first surface and used for inputting or outputting a signal. The first capacitor conductor layer may be electrically connected to the signal terminal.

The multilayer electronic component according to one embodiment of the disclosure may further include a shield conductor formed of a conductor and integrated with the stack. The shield conductor may cover the first side surface, the second side surface, the third side surface, and the fourth side surface.

In the multilayer electronic component of the disclosure, the first end of the at least one first columnar conductor of the first structure is connected to the first ground conductor layer. Furthermore, the at least one first columnar conductor is disposed between the first capacitor conductor layer and the first side surface. With such a configuration, the disclosure can realize a multilayer electronic component capable of achieving adjustment of the characteristics within the structural restrictions.

Obviously, various aspects and modification examples of the disclosure can be practiced in the light of the above teachings. Thus, it is to be understood that, within the scope of the appended claims and equivalents thereof, the disclosure can be practiced in other forms than the foregoing example embodiments.

1. A multilayer electronic component comprising:
a first capacitor;
a first ground conductor layer connected to a ground;
a first capacitor conductor layer that constitutes, cooperatively with the first ground conductor layer, at least a part of the first capacitor;
a first structure formed of a conductor; and
a stack that integrates the first capacitor, the first ground conductor layer, the first capacitor conductor layer, and the first structure, the stack including a plurality of dielectric layers stacked together, wherein:
the first structure includes at least one first columnar conductor extending in a direction parallel to a stacking direction of the plurality of dielectric layers, the at least one first columnar conductor having a first end and a second end that are located on sides opposite each other in the stacking direction;
the first end is connected to the first ground conductor layer;
the stack further includes another conductor for constituting at least one component other than the first capacitor and the first structure;
the other conductor is not connected to the second end;
the stack includes a first surface and a second surface located at both respective ends of the stack in the stacking direction, and a first side surface, a second side surface, a third side surface, and a fourth side surface that connect the first surface and the second surface;
the first side surface and the second side surface face opposite directions;
the third side surface and the fourth side surface face opposite directions; and
the at least one first columnar conductor is disposed between the first capacitor conductor layer and the first side surface.

2. The multilayer electronic component according to claim 1, wherein the first ground conductor layer is disposed at a position closer to the first surface than to the second surface, and
the first structure is disposed between the first ground conductor layer and the second surface.

3. The multilayer electronic component according to claim 1, wherein the at least one first columnar conductor includes a plurality of first columnar conductors arranged in a direction orthogonal to the stacking direction.

4. The multilayer electronic component according to claim 1, wherein the first structure further includes at least one conductor layer connected to the at least one first columnar conductor.

5. The multilayer electronic component according to claim 1, further comprising a band-pass filter including the first capacitor, and at least one inductor integrated with the stack.

6. The multilayer electronic component according to claim 5, further comprising:
a second capacitor;
a second ground conductor layer connected to the ground;
a second capacitor conductor layer that constitutes, cooperatively with the second ground conductor layer, at least a part of the second capacitor; and
a second structure formed of a conductor, wherein:
the second capacitor, the second ground conductor layer, the second capacitor conductor layer, and the second structure are integrated with the stack;
the second structure includes at least one second columnar conductor extending in a direction parallel to the stacking direction, the at least one second columnar conductor having a third end and a fourth end that are located on sides opposite each other in the stacking direction;
the third end is connected to the second ground conductor layer;
the at least one component does not include the second capacitor and the second structure;
the other conductor is not connected to the fourth end; and
the at least one second columnar conductor is disposed between the second capacitor conductor layer and one of the second side surface, the third side surface, and the fourth side surface.

7. The multilayer electronic component according to claim 6, further comprising an inductor disposed between the first structure and the second structure.

8. The multilayer electronic component according to claim 1, further comprising a signal terminal disposed on the first surface and used for inputting or outputting a signal, wherein
the first capacitor conductor layer is electrically connected to the signal terminal.

9. The multilayer electronic component according to claim 1, further comprising a shield conductor formed of a conductor and integrated with the stack, wherein
the shield conductor covers the first side surface, the second side surface, the third side surface, and the fourth side surface.
